(19) United States
(12) Patent Application Publication
(10) Pub. No.: US 2009/0315894 A1
(43) Pub. Date: Dec. 24, 2009

(54) BROWSER-INDEPENDENT ANIMATION ENGINES

(75) Inventor: Gideon Goodwin, Mountain View, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,906

(22) Filed: Jun. 18, 2008

(51) Int. Cl. G06T 13/00

(52) U.S. Cl. 345/473

(57) ABSTRACT

Tools and techniques are described for browser-independent animation engines. These animation engines may include browser-independent animation objects that represent entities that may be animated within a browser. These animation objects may define animation attributes, with the animation attributes being associated with attribute values that describe aspects of the entity. The animation attributes may also be associated with animation evaluators that define how the attribute value changes over time. These animation engines may also include a browser-specific layer for interpreting the attribute values into instructions specific to the browser.

### BACKGROUND

Over the years, a wide variety of different browsers have entered the marketplace, some with more commercial success than others. Improvements to existing browsers, as well as new browsers, continue to enter the marketplace. Web applications may execute within these browser environments. In some cases, these Web applications may provide animations within the browsers.

### SUMMARY

Tools and techniques are described for browser-independent animation engines. These animation engines may include browser-independent animation objects that represent entities that may be animated within a browser. These animation objects may define animation attributes, with the animation attributes being associated with attribute values that describe aspects of the entity. The animation attributes may also be associated with animation evaluators that define how the attribute value changes over time. These animation engines may also include a browser-specific layer for interpreting the attribute values into instructions specific to the browser.

The above-described subject matter may also be implemented as a method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments for browser-independent animation engines.

FIG. 2 is a combined block and flow diagram illustrating additional aspects of interactions between client systems and server systems in connection with providing the browser-independent animation engines.

FIG. 3 is a block diagram illustrating data structures or data hierarchies for constructing storage elements in connection with providing the browser-independent animation engines.

FIG. 4 is a combined block and flow diagram illustrating components and data flows related to architectures for the browser-independent animation engines.

FIG. 5 is a flow chart illustrating processes for operating the browser-independent animation engines.

FIG. 6 is a flow chart illustrating processes for animating objects using the browser-independent animation engines described herein.

### DETAILED DESCRIPTION

The following detailed description is directed to technologies for browser-independent animation engines. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of tools and techniques for browser-independent animation engines will be described.

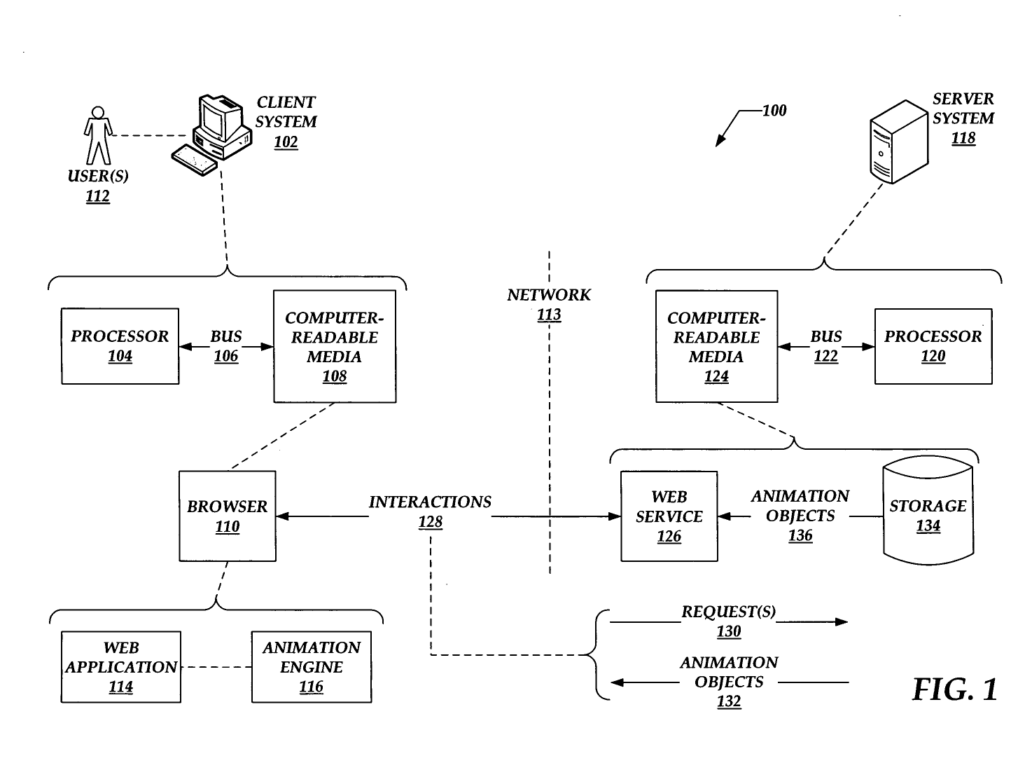

FIG. 1 illustrates systems or operating environments, denoted generally at 100, for browser-independent animation engines. These systems 100 may include one or more client systems 102, with FIG. 1 illustrating one client system for clarity only. However, implementations of the description herein may include any number of client systems.

Turning to the client systems 102 in more detail, these may include one or more processors 104, which may have a particular type or architecture, chosen as appropriate for particular implementations. The processors 104 may couple to one or more bus systems 106 chosen for compatibility with the processors 104.

The client systems 102 may also include one or more instances of computer-readable storage media 108, which couple to the bus systems 106. The bus systems may enable the processors 104 to read code and/or data to and/or from the computer-readable storage media 108. The media 108 may represent storage elements implemented using any suitable technology, including but not limited to semiconductors, magnetic materials, optics, or the like. The media 108 may include memory components, whether classified as RAM, ROM, flash, or other types, and may also represent hard disk drives.

The storage media 108 may include one or more data structures and modules of instructions that, when loaded into the processor 104 and executed, cause the client systems 102 to perform various tools and techniques relating to browser-independent animation engines. Examples of these modules may include a web browser 110. In general, the browser 110 may enable one or more users 112 to access content by navigating within one or more networks 113. These networks 113 generally represent any protocols, adapters, components, and other general infrastructure associated with wired and/or wireless communications networks. Such networks 113 may be global, regional, local, and/or personal in scope and nature, as appropriate in different implementations.

In example scenarios, the browser 110 may enable the user 112 to access particular websites to execute instances of web applications 114. More specifically, these websites may host content that may be animated within the web applications 114. Accordingly, the storage media 108 may include one or more instances of an animation engine 116 operative to render animated content within the web application 114. In example scenarios, the animation engine may be implemented within an interpreter that processes JAVASCRIPT™ functions within the web browser 110. However, more generally, the animation engine may be implemented using any scripting environment or platform that is common across different browsers, and that may be executed by those different browsers.

The operating environments 100 may also include one or more instances of server systems 118. These server systems 118 may include one or more processors 120, which may have a particular type or architecture, chosen as appropriate for particular implementations. The processors 120 may or may not have the same type and/or architecture as the processors 104. The processors 120 may couple to one or more bus systems 122 chosen for compatibility with the processors 120.

The server systems 118 may also include one or more instances of computer-readable storage media 124, which couple to the bus systems 122. The bus systems may enable the processors 120 to read code and/or data to and/or from the computer-readable storage media 124. The media 124 may represent storage elements implemented using any suitable technology, including but not limited to semiconductors, magnetic materials, optics, or the like. The media 124 may include memory components, whether classified as RAM, ROM, flash, or other types, and may also represent hard disk drives.

The storage media 124 may include one or more data structures and modules of instructions that, when loaded into the processor 120 and executed, cause the server systems 118 to perform various tools and techniques relating to browser-independent animation engines. For example, these modules may provide web services, denoted generally at 126, with which one or more client systems 102 may interact. FIG. 1 generally denotes at 128 these interactions between the server systems 118 and the client systems 102. In general, these interactions 128 may represent any number of requests 130 submitted by any number of client systems 102 to server systems 118. These requests 130 may include requests for animation objects to be animated and rendered within the web application 114 by the animation engine 116. FIG. 1 denotes examples of these animation objects at 132, as provided by the server system 118 to the client system 102.

The storage media 124 may also include storage elements 134, which may contain any number of animation objects. In response to the requests 130, the web service 126 may retrieve representations of animation objects from the storage elements 134. FIG. 1 denotes at 136 examples of the animation objects as provided by the storage elements to the Web service.

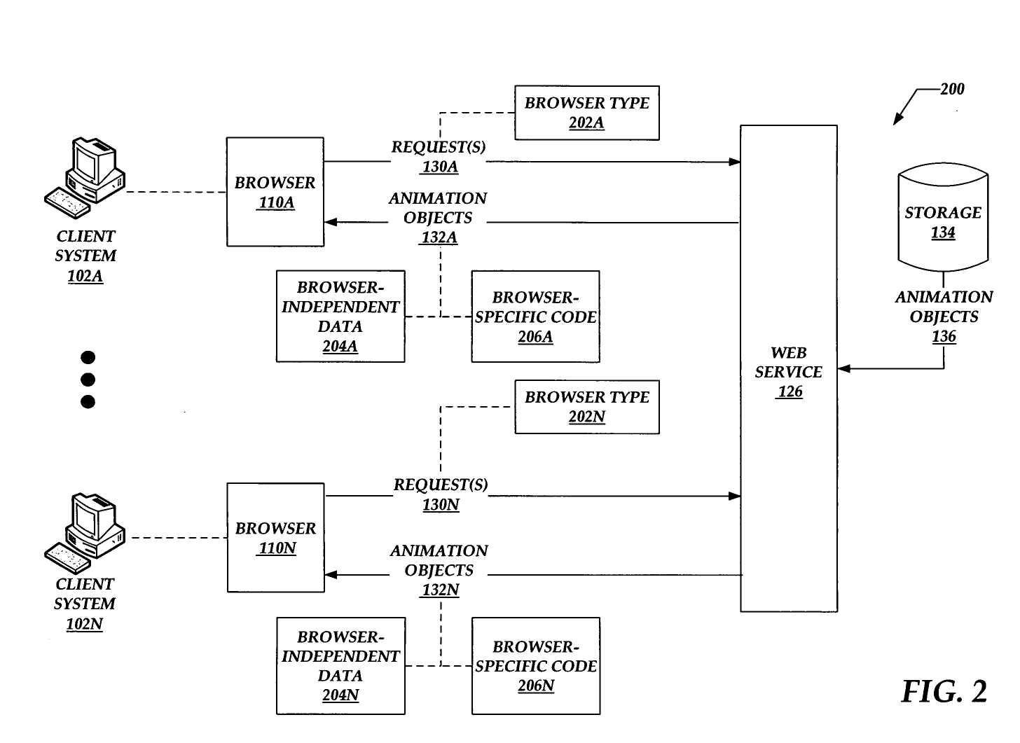

Having described the components of the overall operating environments 100, the discussion now turns to a more detailed description of the interactions between client systems 102 and the web service 126 operated by the server system 118. This description is now provided with FIG. 2.

FIG. 2 illustrates additional aspects, denoted generally at 200, relating to the interactions between client systems and server systems in connection with providing browser-independent animation engines. For convenience of description, but not to limit possible implementations, FIG. 2 may carry forward some elements from previous drawings, and denote them with identical reference numbers. For example, FIG. 2 carries forward examples of the storage elements at 134, which may provide replications of the animation objects 136 to the Web service 126.

FIG. 2 illustrates two client systems 102a and 102n, which represent different instances of the client systems 102 shown in FIG. 1. Turning to the client system 102a, for example, this client system may present one or more instances of the browser 110 shown in FIG. 1, denoted at 110a in FIG. 2. The browser 110a may be operative to submit any number of requests 130a to the Web service 126. The requests 130a may represent requests for animation data for animating one or more particular animation objects. This animation data is browser-independent and browser-agnostic, meaning that the animation data may animate the without knowledge of the underlying browser to which the animation objects are ultimately rendered.

The requests 130a may also represent requests for code that interprets the animation data for a given particular browser. In these latter cases, in which the requests pertain to browser-specific code, the requests 130a may indicate a type or class of the browser 110a, as indicated generally at 202a, in which particular requested objects are to be animated.

In example scenarios, browsers may be classified based on the type of graphical support or rendering technologies that they offer or support. For example, some browsers (e.g., the INTERNET EXPLORER® Internet browser, available from Microsoft Corporation) may employ the Vector Markup Language (VML) to markup vector graphic information. Other browsers (e.g., the FIREFOX® browser, available from Mozilla) may employ the scalable vector graphics (SVG) language.

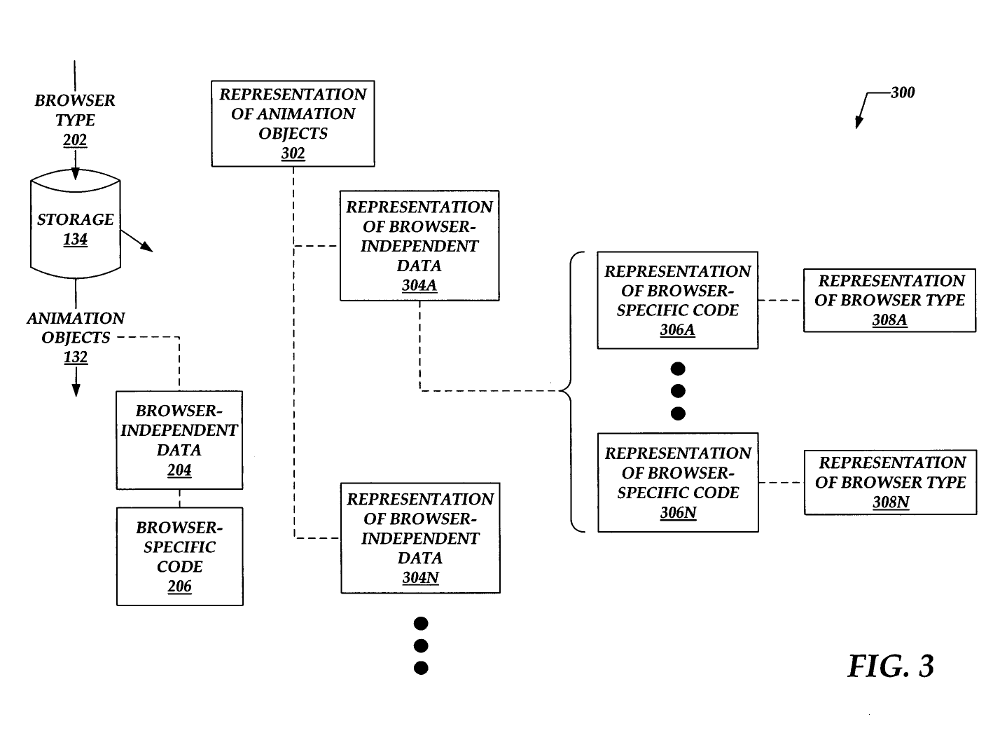

In turn, the Web service 126 may receive the request 130a, which references the browser type 202a. As described in further detail below in connection with FIG. 3, the web service 126 may search the storage elements 134 for any requested animation objects 136, as well as any browser-independent animation data 204a and any code 206a that is specific to the browser 110a. Assuming this search is successful, the web service 126 may return any matching animation objects, denoted at 132a. As described in further detail below, these animation objects 132a may contain the browser-independent animation data 204a, as well as the browser-specific code 206a for interpreting the animation data for the particular browser 110a. Because the request 130a indicates the browser type at 202a, the Web service 126 and storage elements 136 may provide the browser-specific code 206a for the particular browser 110a.

Turning to the client system 102n, a browser 110n associated with this client system may submit corresponding requests 130n to the Web service 126. These requests 130n may designate particular requested animation objects, as well as browser-independent data for animating the objects. The requests 130n may also include a representation of a browser type or class, as represented generally at 202n, to which the animation objects will be rendered. In turn, the Web service 126 may receive and process the request 130n.

As described above with the client system 102a, the Web service 126 may search the storage elements 134 for any animation objects 136 that are responsive to the request 130n. As described above, the animation objects may contain browser-specific data for animating the objects agnostically within a variety of different browsers. In addition, the Web service may search for any browser-specific code appropriate for the type or class of the browser 110n, as indicated by the browser type representation 202n. Assuming this search is successful, the Web service 126 may return the requested animation objects 132n, as well as browser-independent animation data 204n, and browser-specific code 206n for interpreting the animation data for the specified browser.

It is noted that the browser-independent animation data 204a and 204n (collectively, browser-independent data 204) may be the same across a plurality of different browsers 110. FIG. 1 denotes these items with separate reference numbers only for ease of identification. It is further noted that the browser-specific code 206a and 206n (collectively, browser-specific code 206) may be different across the browsers 110. For example, the browsers 110a and 110n may support different rendering technologies, or may otherwise offer or support different capabilities. In light of these differences, the browser-specific code 206a and 206n may interpret the browser-independent animation data 204 differently for the respective browsers 110a and 110n.

Having described the additional aspects relating to the interactions between client systems and server systems with FIG. 2, the discussion now turns to a description of illustrative data structures for the storage elements 134. This discussion is now presented with FIG. 3.

FIG. 3 illustrates data structures or data hierarchies, denoted generally at 300, for constructing storage elements in connection with providing browser-independent animation engines. For convenience of description, but not to limit possible implementations, FIG. 3 may carry forward some elements from previous drawings, and denote them with identical reference numbers. For example, FIG. 3 carries forward an example of the storage elements at 134. As described above, the storage elements 134 may receive indications of browser types or classes (e.g., 202). In turn, the storage elements 134 may return animation objects 132, which may contain browser-independent animation data 204 and browser-specific code 206 for interpreting the animation data for particular browsers.

Turning to FIG. 3 in more detail, the data structures 300 may contain representations of any number of animation objects 132. FIG. 3 denotes at 302 representations of these animation objects as contained in the storage elements 134. The storage elements 134 may contain any number of representations 302 of the animation objects. Thus, FIG. 3 provides one example of these representations 302 only for clarity of illustration, but not to limit possible implementations.

As shown in FIG. 3, the representations 302 of the animation objects may include representations 304a and 304n (collectively, representations 304) of the browser-independent animation data 204. For example, the representations 304 may include data (e.g., specified in suitable markup language) for implementing browser-independent components 204 of different animation objects 132.

Turning to the representation 304a in more detail, it may be associated with representations 306a and 306n (collectively, representations 306) of different instances of the browser-specific code 206. More specifically, the representation 306a may be associated with browser-specific code (e.g., specified in suitable markup language) for interpreting the browser-independent data represent in 304a for a type or class of browser. FIG. 3 denotes a representation of the type or class of browser generally at 308a.

The animation engines described herein may employ pluggable architectures. In these pluggable architectures, the browser-independent data components 204 and one or more browser-specific code components 206 may cooperate to enable a given instance of the animation engine to operate with different browsers, depending on which browser-specific data components are “plugged in” with the browser-independent code components.

In addition, the representation 306n may be associated with browser-specific code or markup for interpreting the browser-independent data represented at 304a for a different type or class of browser, denoted generally at 308n. In example implementation scenarios, the storage elements 134 may be organized so as to retrieve the browser-specific code 206 by searching the representations of the browser types 308 for any matches with the input browser type 202. Assuming that one of the representations 308 matches the input browser type 202, the storage elements 134 may return the representation 306 of the browser-specific code that corresponds to the matching representation 308.

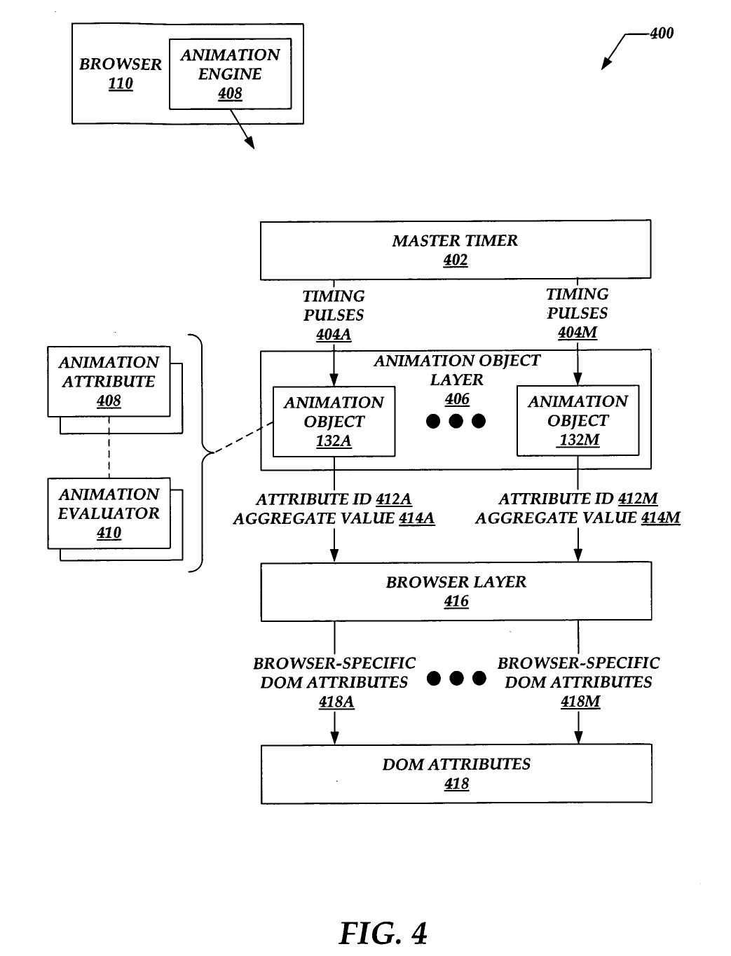

Having described the data structures of the storage elements 134 in connection with FIG. 3, the discussion now turns to a more detailed description of the animation engine 116 as shown in FIG. 1. This description is now provided with FIG. 4.

FIG. 4 illustrates components and data flows, denoted generally at 400, related to architectures for browser-independent animation engines. For convenience of description, but not to limit possible implementations, FIG. 4 may carry forward some elements from previous drawings, and denote them with identical reference numbers. For example, FIG. 4 carries forward an example of the animation engine at 116, which may render animating entities within the browser 110.

Turning to FIG. 4 in more detail, the animation engine 116 may include a master timer component 406 operative to generate timing pulses 404a and 404m (collectively, timing pulses 404). The animation engine 116 may also include an animation object layer 406, which may further include any number of animation objects, with FIG. 4 carrying forward instances of animation objects at 132a and 132m. It is noted that the animation object layer 406 may contain any number of animation objects 132, with the example shown in FIG. 4 provided only to facilitate the present description.

The animation objects 132 represent respective entities that are animating within the browser 110. Turning to the animation object 132a as an example, the animation objects 132 may generally include one or more animation attributes 408. The animation attributes 408 may represent abstract properties of a given entity, and values of the animation attributes may change over time as the given entity animates within the browser 110.

In general, examples of these abstract properties may include any properties of an object that can change over time, and is supported or has meaning to a given browser. More specific examples of these abstract properties may include locations of the given entity (e.g., expressed as X and Y coordinates), color changes over time (if supported by the browser 110), or the like.

Other examples of these abstract properties may include a fade-in and/or fade-out function (i.e., a “blinds” property) as supported by various applications, such as presentation software. The animation engine may animate this blinds property from 0 to 1 over time.

Another example of an animating property may include an alpha level, which specifies a level of transparency or opacity with which a given object may be rendered. Alpha levels may range from 0 (completely transparent) to 1 (completely opaque).

The abstract properties may also include discrete lists. Examples of these discrete lists may include lists of different images, through which the animation object may traverse, animating these images over time. For example, assuming that a given discrete list contains a sequence of ten images, these images may be associated with a respective index (e.g., the integers 1 through 10).

Examples of animating objects or entities may include elements displayed within presentations created using presentation software (e.g., the POWERPOINT® presentation graphics program available from Microsoft Corporation). animating objects may also include, but are not limited to, animated elements presented within games, advertisements, animated media, or the like.

The animation attributes 408 may be associated with one or more animation evaluators 410, which specify or define how the animation attributes values change over time as the given entity animates. More specifically, the animation objects 132a and 132m may respectively receive indications of the timing pulses 404a and 404m. In response to these timing pulses, the animation evaluators 410 may calculate and update their respective animation attributes 408, as specified by the animation evaluators 410.

The animation evaluators 410 may employ various rules to perform the calculations described herein. For example, linear interpolation rules may animate a given object from a start state to at least one end state, at a given rate of change. A constant rule is a special case of the linear interpolation rules, performing a linear projection with the start and end states being the same. Bezier rules may calculate curves motion paths involved in certain animations, while quadratic rules may simulate the effects of gravity in some animations. The animation evaluators 410 may also traverse entries in discrete lists, which are described elsewhere herein.

The animation objects 132 may output respective attribute identifiers (IDs) 412a and 412m (collectively, attribute IDs 412), which identify particular animation attributes 408. In addition, the animation objects 132 may also output respective aggregated values 414a and 414m (collectively, aggregated values 414), which represent updated values as calculated for the animation attributes 408 in response to the timing pulses 404. In instances when multiple animation evaluators 410 are associated with a given animation attribute for a way to, the values 414 may be aggregated to incorporate contributions of these multiple animation evaluators.

The animation engine 116 may include a browser layer 416, which corresponds to a particular type or class of browser supported by the animation engine 116. More specifically, the browser layer 416 may receive aggregated values 414 computed for the various animation objects 132, and may interpret these values as browser-specific instructions as appropriate for the class or type of browser represented in the browser layer 416.

In some implementations, the entities animating within the browser 110, corresponding to the animation objects 132a and 132m, may be represented using a document object model (DOM). In such implementations, the browser layer 416 may output browser-specific DOM attributes 418a and 418m (collectively, DOM attributes 418), corresponding respectively to the animation objects 132a and 132m.

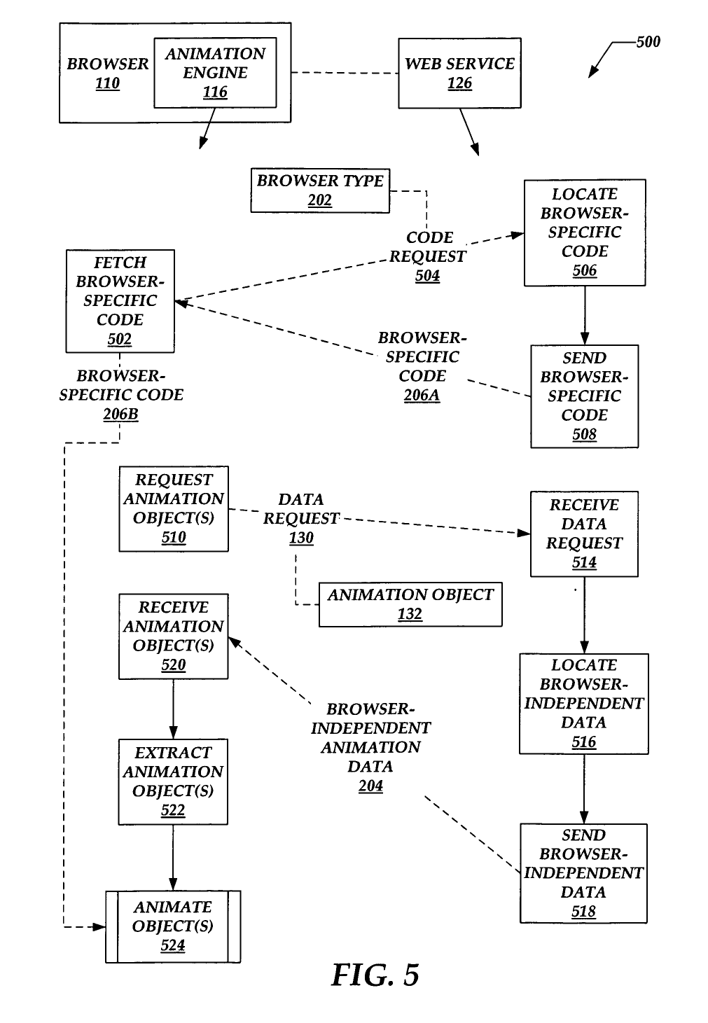

Having described the illustrative architectures for the animation engine in FIG. 4, the discussion now turns to a description of process flows related to operating browser-independent animation engines. This description is now provided with FIG. 5.

FIG. 5 illustrates process flows, denoted generally at 500, related to operating the browser-independent animation engines. For purposes of this description, but not to limit possible implementations, the process flows 500 are illustrated and described in connection with the client system 102 and the server system 118. However, implementations of this description may perform at least portions of the process flows 500 using other components without departing from the scope and spirit of this description. In addition, these process flows are described as proceeding in certain orders only for purposes of this description, and implementations of these process flows may proceed in different orders as well.

In addition, for convenience of description, but not to limit possible implementations, FIG. 5 may carry forward some elements from previous drawings, and denote them with identical reference numbers. For example, FIG. 5 carries forward an example of the animation engine at 116, which may render animating entities within the browser 110 on the client system 102. FIG. 5 also carries forward an example of the Web service at 126, as associated with the server system 118.

Turning to the process flows 500 in more detail, block 502 represents the animation engine 116 fetching browser-specific code from the server system 118. The process flows 500 may perform block 502 in connection with launching a web application within the browser 110.

FIG. 5 denotes at 504 an example request for the browser-specific code. This request 504 may reference or indicate a type or class of the browser 110, as carried forward at 202.

Referring to the Web service 126, block 506 represents receiving the request 504 from the animation engine. Block 506 may also include referring to the indication of the browser type 202, and may include locating any instances of browser-specific code appropriate for interpreting animation data for browsers of the type or class as indicated at 202. Recalling the previous discussion of FIG. 3, block 506 may include searching the storage elements 134 for any browser type representations 308 that match the browser type 202 specified within a given code request 504.

Block 508 represents sending browser-specific code 206a that corresponds to the code request 504. FIG. 3 provides examples of such browser-specific code or markup at 306a and 306n.

Block 510 requesting one or more animation objects (e.g., 132 in FIG. 1). As described above, the animation objects may be associated with browser-independent animation data (e.g., 204 in FIG. 2), which specifies how to animate the animation objects without reference to any particular underlying browser. FIG. 5 denotes at 512 the request for this browser-independent animation data.

At the web service, block 514 represents receiving the data request 512. Block 5. Block 514 may include identifying the animation object(s) 132 referenced in the request 512.

Block 516 represents locating browser-independent animation data for the animation object specified in the request 512. Block 516 may include searching storage elements (e.g., 134) for any representations of animation objects that match the animation objects specified in the request 512.

Block 518 represents sending the browser-independent animation data, in response to the request 512. FIG. 5 carries forward an example of browser-independent code at 204. In some cases, block 518 may include building a data structure that incorporates the browser-independent code and/or the browser-specific code located for the incoming request 512. The data structure built or constructed in block 518 may be a run-time data structure that enables the animation engine to animate the requested animation object within the browser 110.

In some cases, the web application may present a given animation that utilizes certain browser-specific code, and block 502 may fetch this browser-specific code, if not already fetched. Once fetched, the browser-specific code may be cached for later access. For example, if the web application presents another animation that utilizes the same browser-specific code, then the web application may refer to the cached instance of the browser-specific code, rather than repeating block 502 to re-fetch the same code.

At the animation engine 116, block 520 represents receiving the browser-independent data 204 sent by the Web service 126. As described above, in different scenarios, the client system may receive, for one or more given animation objects, browser-independent data for animating the object.

Block 522 represents extracting browser-independent data from the animation object received in block 520. In cases in which the web service sends a run-time data structure containing the browser-independent data, block 518 may include extracting representations of the browser-independent data from the data structure received in block 520.

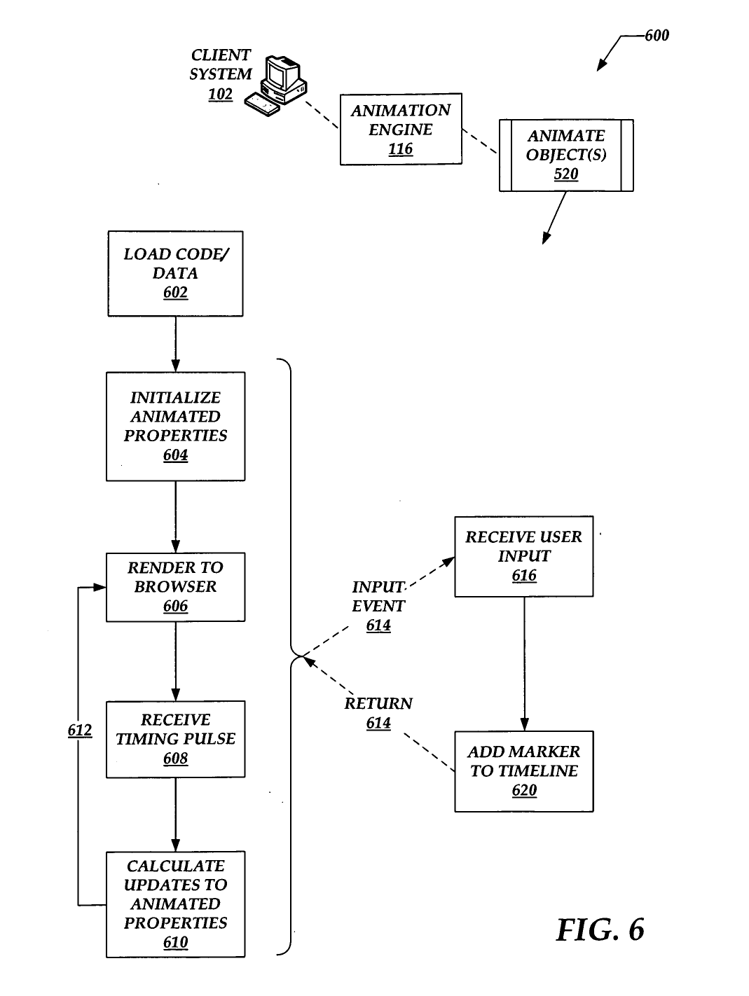

Block 524 represents animating the animation object extracted in block 522. More specifically, block 524 may include processing the browser-independent animation data to animate the object within a given browser. As such, block 524 may include receiving a representation of browser-specific code 206b, which interprets the browser-independent animation data for the given browser. In the interests of clarity, the discussion now turns to FIG. 6 to discuss block 524 in more detail.

FIG. 6 illustrates process flows, denoted generally at 600, for animating objects using the browser-independent animation engines described herein. For convenience of description, but not to limit possible implementations, FIG. 6 may carry forward some elements from previous drawings, and denote them with identical reference numbers. For example, FIG. 6 carries forward an example of the animation engine at 116, which may render animating entities within the client system 102.

Block 602 represents accessing the code or markup received or a given animation object by the client system. Block 602 may also include loading this code or markup into the animation engine 116 in preparation for rendering the animation object locally at the client system 102. More specifically, block 602 may include loading the animation engine with browser-independent animation data.

As described above in connection with FIG. 4, a given animation object (e.g., 132a in FIG. 4) may include any number of animated properties (e.g., 408). Block 604 represents initializing the animated properties within a given animation object. More specifically, block 604 may include establishing an initial state for rendering the animation object on the client system 102.

Block 606 represents rendering the animated properties to a browser window (e.g., 110 in FIG. 1). In turn, block 608 represents receiving a timing pulse associated with animating the given animation object. For example, referring briefly back to FIG. 4, a master timer 402 may generate timing pulses 402 that govern the animation of a given object.

Block 610 represents calculating an updated state of the animated properties in response to the timing pulse received in block 608. For example, block 610 may include processing the animation evaluators (e.g., 410) associated with a given animation object in response to the timing pulse, and updating the animated property as indicated by the animation evaluator at the given time. For example, the animation evaluator for a given animation object may define a timeline for the animation, with the animation object taking on various states as it progresses along this timeline. Assuming that the timing pulse or trigger received in block 608 identifies or designates a given point along this timeline, block 610 may include calculating the state of the animation at this given point on the timeline.

The processes 600 may loop through blocks 606-610 any number of times until the animation evaluators for a given object indicate that the animation is complete. FIG. 6 generally represents this loop at 612. In the interests of clarity, FIG. 6 does not illustrate testing for when the animation is complete.

At any point within the process flows 600, a user may provide some form of input event, denoted generally at 614. Examples of the input events 614 may include mouse clicks, or the like.

Block 616 represents receiving and processing one or more instances of the input events, in response to the input 614. Block 618 may include creating one or more timing triggers or markers in responses to the input event received from the user. As an example of timing triggers, block 616 may include receiving a command from the user that advances animation to some selected point in the animation. In some cases, a given animation object may define one or more discrete, predefined points within the animation that are selectable by the user. In other cases, the animation object may allow the user to select any point within the animation. Thus, the timeline defined for a given animation object may be “random access,” in the sense that a user may access any point in the timeline.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

In addition, certain process and data flows are represented herein as unidirectional only for the purposes of facilitating this description. However, these unidirectional representations do not exclude or disclaim implementations that incorporate bidirectional flows.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. At least one computer-readable storage medium having computer-executable instructions stored thereon which, when executed by a computer, cause the computer to provide at least one animation engine comprising:
at least one browser-independent animation object that represents zero or more entities for animation within a browser, wherein the animation object defines at least one animation attribute, wherein the animation attribute is associated with at least one attribute value that describes an aspect of the entity, and wherein the animation attribute is associated with at least one animation evaluator that defines how the attribute value changes over time; and
a browser-specific layer for interpreting the attribute value into at least one instruction specific to the browser.

2. The storage medium of claim 1, wherein the animation engine further comprises a master timer operative to generate timing pulses received by at least the animation object.

3. The storage medium of claim 2, wherein the animation evaluator is responsive to the timing pulse to calculate a state of the animation attribute.

4. The storage medium of claim 1, wherein the animation engine further comprises at least a second browser-independent animation object that represents at least a second entity for animation within the browser, wherein the second animation object defines at least a second animation attribute, wherein the second animation attribute is associated with at least a second attribute value that describes at least a second aspect of the second entity, and wherein the second attribute value is associated with at least a second animation evaluator that defines how the second attribute value changes over time.

5. The storage medium of claim 1, wherein the browser has a first type, and wherein the browser-specific layer is for interpreting the attribute value into at least a second instruction specific to a second browser having a second type different from the first type.

6. The storage medium of claim 1, wherein the browser-independent animation object is operative to receive an indication of a timing trigger in response to user input.

7. The storage medium of claim 6, wherein the animation evaluator is responsive to the timing trigger to calculate the attribute value at the timing trigger.

8. The storage medium of claim 1, wherein the browser-specific layer is for rendering the entity to the browser by executing at least the instruction.

9. The storage medium of claim 1, wherein the animation engine is for operating in an automatic mode without user input.

10. The storage medium of claim 1, wherein the animation engine is for operating in a manual mode in response to receiving user input.

11. At least one computer-readable storage medium encoded with a data structure, the data structure comprising:
a representation of at least one animation object that corresponds to an entity for animation within a plurality of browsers, wherein the browsers include a first browser that provides a first type of graphic support and at least a second browser that provides a second type of graphic support different from the first type;
a representation of browser-independent data, associated with the animation object, that defines at least one animation attribute, wherein the animation attribute is associated with at least one attribute value that describes an aspect of the entity, and wherein the animation attribute is associated with at least one animation evaluator that defines how the attribute value changes over time; and
a plurality of representations of browser-specific code associated with the animation object, wherein a first one of the representations of browser-specific code is for interpreting the attribute value into at least one instruction specific to the first browser, and wherein a second one of the representations of browser-specific code is for interpreting the attribute value into at least one instruction specific to the second browser.

12. The storage medium of claim 11, wherein the data structure further comprises at least a second representation of at least a second animation object, wherein the second animation object corresponds to a second entity for animation within the first and second browsers.

13. The storage medium of claim 11, wherein the data structure further comprises a representation of the first type, which representation is associated with the first representation of browser-specific code.

14. The storage medium of claim 13, wherein the data structure is configured to receive an indication of an input browser type, and to search at least the representation of the first type to determine whether the first type matches with the input browser type.

15. The storage medium of claim 14, wherein the data structure is configured to determine that the first type matches with the input browser type, and to return the representation of browser-specific code corresponding to the first type.

16. The storage medium of claim 11, wherein the data structure further comprises a representation of the second type, which representation is associated with the second representation of browser-specific code.

17. At least one computer-readable storage medium having computer-executable instructions stored thereon which, when executed by a computer, cause the computer to perform a method comprising:
receiving a first request for at least one animation object, wherein the request references a first browser;
locating at least one instance of browser-independent data for animating the animation object;
locating at least a first instance of browser-specific code for interpreting the browser-independent data within the first browser;
sending at least the first browser specific code in response to the first request;
receiving at least a second request for the animation object, wherein the second request references a second browser different than the first browser;
locating at least a second instance of browser-specific code for interpreting the browser-independent data within the second browser; and
sending at least the second browser-specific code in response to the second request.

18. The storage medium of claim 17, further comprising instructions for building a data structure that incorporates at least the first instance of the browser-specific code, and further comprising instructions for sending the data structure in response to the first request.

19. The storage medium of claim 17, further comprising instructions for building a data structure that incorporates at least the second instance of the browser-specific code, and further comprising instructions for sending the data structure in response to the second request.

20. The storage medium of claim 17, wherein the instructions for receiving a first request include instructions for receiving a request that references a browser that provides a first type of graphic support, and wherein the instructions for receiving a second request include instructions for receiving a request that references a browser that provides a second type of graphic support, wherein the second type of graphic support is different than the first type.
